(19) United States
(12) Patent Application Publication
(10) Pub. No.: US 2009/0315505 A1
(43) Pub. Date: Dec. 24, 2009

(54) SYNCHRONOUS MOTOR, MOTOR SYSTEM AND METHOD FOR OPERATING A MOTOR SYSTEM

(76) Inventors: Joachim Denk, Nurnberg (DE); Dietmar Stolber, Furth (DE); Bernd Wedel, Mohrendorf (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/375,953

(22) PCT Filed: Jul. 26, 2007
(86) PCT No.: PCT/EP07/57721

§ 371 Date: Feb. 2, 2009

(30) Foreign Application Priority Data
Aug. 3, 2006 (DE) 10 2006 036 289.6

(51) Int. Cl. H02P 6/08; H02K 21/04

(52) U.S. Cl. 318/718; 310/210

(57) ABSTRACT

The invention relates to a synchronous motor (12,32) having a number of stator coils and an armature (16, 36) having at least one permanent magnet (17, 37) which produces a magnetic field in a main flux direction, having at least one coil winding (20, 40) which is fitted to the armature (16, 36) such that a component of an alternating magnetic field, which is applied with the aid of the stator coils (15, 35), can be used to induce in it a secondary current which can be tapped off by means of a load (25, 45) which can be arranged adjacent to the armature.

The invention relates to a synchronous motor having a number of stator coils and having an armature which has at least one permanent magnet. The invention also relates to a motor system having such a synchronous motor and to a method for operating such a motor system.

A synchronous motor usually has an arrangement with stator coils which are in each case energized with a drive current in an appropriate manner in order to generate a driving magnetic field. The driving magnetic field drives an armature provided with at least one permanent magnet. In the case of an armature constructed as a rotor, the driving magnetic field is always applied in such a manner that it exists perpendicularly to a main flux direction of the magnetic armature field produced by the permanent magnet.

A synchronous motor is distinguished by the fact that the armature only comprises permanent magnets and no coils and thus does not need a commutator or other devices with brushes, wipers and the like for supplying a coil current to the armature. In some applications using a synchronous motor it may be necessary, however, that a supply current is needed on the armature for supplying electrical power to a load located there.

Using a commutator or other devices using wipers or brushes for applying a supply current to the armature is disadvantageous since these exhibit increased wear and must therefore be maintained regularly to provide correct operation.

It is the object of the present invention to provide a synchronous motor in which an additional supply current can be provided on the armature without needing devices with increased wear for providing the supply current. It is also an object of the present invention to provide a motor system and a method for operating such a motor system in which a supply current can be provided at the armature whilst exhibiting little wear.

This object is achieved by the synchronous motor as claimed in claim 1, the motor system as claimed in claim 8 and the method for operating such a motor system as claimed in claim 10.

Other advantageous embodiments of the invention are specified in the dependent claims.

According to a first aspect of the present invention, a synchronous motor is provided which has a number of stator coils and an armature having at least one permanent magnet. The permanent magnet on the armature produces a magnetic armature field in a main flux direction. Furthermore, at least one coil winding is fitted to the armature in order to induce in the coil winding, by means of a component of an alternating magnetic field applied with the aid of the stator coils, a secondary current which can be tapped off by means of a load which can be arranged at the armature.

The synchronous motor according to the invention makes it possible to induce in a simple manner a supply current into the coil winding arranged adjacent to the armature, only by using the stator coils so that additional primary windings at the stator are not required. For this purpose, apart from the driving currents needed for driving the armature, at the stator coils corresponding primary currents are also applied which generate an alternating magnetic field in the direction of the winding axis of the coil winding arranged at the armature in order to induce a secondary current in the coil winding. As a result, a supply current is available as secondary current on the armature without having to provide a brush or wiper arrangement susceptible to wear for transmitting the supply current.

According to one embodiment of the invention a load which is connected to the coil winding in order to apply the secondary current to the load is provided at the armature.

The coil winding is preferably arranged at the armature so that its winding axis extends in parallel with the main flux direction of the magnetic armature field produced by the permanent magnet. As a result, the alternating magnetic field applied to the stator coils for inducing the supply current cannot influence the driving magnetic field for driving the armature, since the alternating magnetic field does not produce any additional driving force on the armature.

The armature can also have a rotor, the at least one permanent magnet arranged at the rotor producing a magnetic field having at least one radial component with respect to a rotor axis.

The coil winding preferably encloses the at least one permanent magnet at least partially.

Furthermore, poles of the at least one permanent magnet can lie opposite one another with respect to a rotor axis of the rotor.

According to a further embodiment of the invention, the synchronous motor can be constructed as a linear synchronous motor, the number of stator coils being arranged in a longitudinal direction.

According to a further aspect of the present invention, a motor system having a synchronous motor previously described and having a control unit for driving the synchronous motor is provided in that the stator coils are energized with a respective driving current in such a manner that a driving magnetic field is generated in a direction perpendicular to the main flux direction, the control unit also being arranged for superimposing on the respective driving current a respective primary current which generates the alternating magnetic field in a direction in which a secondary current can be induced in the coil winding, particularly in the main flux direction of the at least one permanent magnet.

Using the stator coils both for applying the driving magnetic field and for inducing the supply current into the coil winding makes it possible to dispense with an additional primary winding for inducting the supply current into the coil winding.

According to a further embodiment of the invention, the control unit can be constructed for superimposing on the respective driving current, on which the corresponding primary current is superimposed, a corresponding field weakening current so that a homogeneous magnetic field is generated in the main flux direction in order to operate the synchronous motor in a field weakening mode.

According to a further aspect of the present invention, a method for operating a motor system having a synchronous motor previously described is provided, the synchronous motor being driven by the stator coils being energized with a driving current in such a manner that a driving magnetic field is generated in a direction perpendicular to the main flux direction, a primary current being superimposed on the driving current, which primary current generates the alternating magnetic field in a direction in which a secondary current is induced into the coil winding, particularly in the main flux direction of the at least one permanent magnet.

Furthermore, a field weakening current can be superimposed on the corresponding driving current, on which the respective primary current is superimposed, in order to generate a homogenous magnetic field in the main flux direction so that a field weakening operation of the synchronous motor can be carried out.

Preferred embodiments of the invention will be explained in greater detail in the text which follows, referring to the attached drawings, in which:

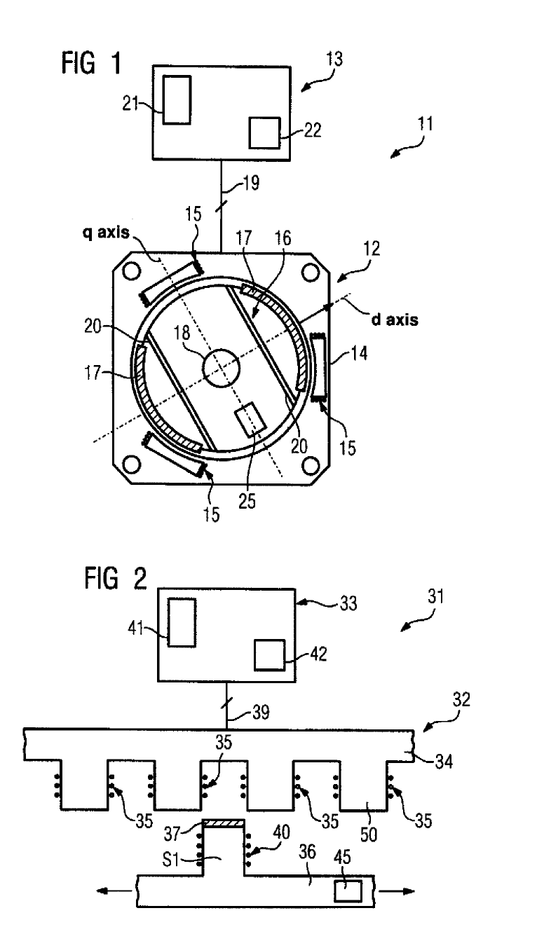

FIG. 1 shows a diagrammatic representation of a motor system according to an embodiment of the present invention;

FIG. 2 shows a diagrammatic representation of a linear synchronous motor according to a further embodiment of the invention.

FIG. 1 shows a diagrammatic representation of a motor system 11 which has a synchronous motor 12 and a driving unit 13. The synchronous motor 12 has a housing 14 in which stator coils 15 are arranged. In the present first exemplary embodiment, three stator coils 15 are arranged offset by 120° in each case with respect to one another and around a rotor 16 located inside. The rotor 16 has two permanent magnets 17 which are arranged as shell-type magnets at opposite sides with respect to a rotor axis 18 of the essentially cylindrical rotor 16. The permanent magnets 17 are unidirectional with their poles so that a magnetic armature field in the direction of a d axis of the rotor 16 through the permanent magnet 17 is formed which corresponds to a main flux direction. The number of stator coils 15 can be essentially freely selected and each of the stator coils 15 can also be arranged as a pair of stator coils on opposite sides of the armature 16 with respect to the rotor axis.

The stator coils 15 are connected to the driving unit 13 via corresponding drive lines 19 so that the stator coils 15 can be activated with the aid of a respective driving current in order to form a resultant driving magnetic field in the area of the rotor 16 which extends at right angles to the main flux direction of the magnetic armature field produced by the permanent magnets 17. To determine the instantaneous main flux direction of the magnetic armature field in each case, the rotor position must be determined which can be done by a suitable position detector. As an alternative, the anisotropy of an inductance resulting in the stator coils can be used for estimating the rotor position in the case of a pickup-less synchronous motor.

The rotor 16 is also provided with one or more coil windings 20 (two in the exemplary embodiment shown), which are connected to a load 25 which can be arranged inside the synchronous motor or at any other position on the rotor axis 18, and is connected to the coil windings 20 in such a manner that a secondary current induced in it can be used as supply current for operating the load 25.

Instead of a primary winding provided in the housing 14 of the synchronous motor 12, the secondary current for supplying the load 25 is induced with the aid of the stator coils 15. The stator coils 15 are energized by the driving unit 13 in such a manner that an alternating magnetic field is produced in the direction of the winding axis of the coil windings 20, in order to generate the secondary current in the current windings 20.

In a preferred exemplary embodiment as shown in FIG. 1, the winding axis of the coil windings 20 extends in parallel with the d axis of the main flux direction of the magnetic armature field produced by the permanent magnets. In this case, it is advantageous that the alternating magnetic field does not have any component in the direction of a q axis of the rotor 16 which is perpendicular to the d axis of the rotor 16, so that the driving of the rotor 16 is not impaired by the alternating magnetic field.

The driving unit 13 has a driver circuit 21 which alternately applies a respective driving voltage to the stator coils 15 via driving lines 19 so that, for example in the case of a uniform speed of rotation of the rotor 16, sinusoidal current variations of driving currents flow through the stator coils 15 which essentially extend offset by 120° in each case with respect to one another. As a result, a resultant driving magnetic field which always extends perpendicularly to the main flux direction of the magnetic armature field produced by the permanent magnets 17, i.e. in the direction of the q axis, is formed in the interior of the synchronous motor 12.

The driving unit 13 also has an input coupling circuit 22 which produces a respective primary current in the stator coils 15 which produce a resultant alternating magnetic field in the direction of the d axis, i.e. in the direction of the winding axis of the coil windings 20.

The alternating magnetic field induces a secondary current in the coil windings 20 with which a load 25 can be supplied. This makes it possible to dispense with a primary coil arrangement in the housing 14 of the synchronous motor 12, for inducing the secondary current as supply current for the load 25. Instead, the stator coils 15 are used for building up the alternating magnetic field in addition to the driving magnetic field. The input coupling circuit 22 produces the respective primary currents in the stator coils 15 by superimposing pulsed primary voltages on the driving voltages at the drive lines 19.

With a pole coverage of less 100%, e.g. of 80%, by the shell-type magnets, the coil winding 20 can be conducted around the shell-type magnets so that the main flux of the magnetic armature field formed by the permanent magnets is not impaired. Instead of the two coil windings 20 shown, a single coil winding can also be provided in the rotor 16, which coil winding is then arranged preferably symmetrically with respect to the axis of rotation. When two or more coil windings 20 are used, attention must be paid to the fact that these are also arranged symmetrically with respect to the axis of rotation so that, on the one hand, no imbalance is produced in the rotor 16 and, on the hand, a uniform induction of the secondary current is achieved.

To achieve higher speeds of rotation of the synchronous motor, a field weakening mode can be provided in which a homogenous magnetic field is applied oppositely to the magnetic armature field with the aid of the stator coils 15, in order to thus reduce the voltage across the stator coils 15 which is produced by the operation of the synchronous motor. For this purpose, apart from the driving currents, field weakening currents are applied by the driver circuit 21 to the stator coils which build up a homogenous magnetic field opposite to the magnetic field of the permanent magnets 17, i.e. a magnetic field in the direction of the d axis in order to reduce the main flux in the main flux direction. In this case, the stator coils 15 are energized with respective total currents which are composed of the driving currents, the field weakening currents and the primary currents for coupling the secondary current into the coil windings 20.

FIG. 2 shows that the principle, described above, of coupling a secondary current into a coil winding arranged on the armature can also be provided in linear motors. In FIG. 2, a linear motor system 31 comprising a linear synchronous motor 32 and a driving unit 33 is provided. The linear synchronous motor 32 has a stator 34 with a number of stator projections 50 which in each case carry one of the stator coils 35. Adjacent stator coils 35 can be energized separately from one another, in each case three mutually adjacent stator coils 35 being preferably energizable separately by the driving unit 33.

Close to the stator 34, an armature is arranged which is arranged movably in a linear direction along the stator 34 with respect to the stator 34. The armature 36 has at least one armature projection 51 on which a permanent magnet 37 is arranged, for producing a magnetic armature field in a main flux direction. The main flux direction is directed in the direction of the stator 34. At the armature projection 51 or around the armature projection, respectively, a coil winding 40 is arranged which is connected electrically to a load 45 arranged on the armature. In this manner, the load 45 can be supplied with electrical power.

The stator coils 35 of the linear synchronous motor 32 are connected to the driving unit 33 via respective drive lines 39. The driving unit 33 has a driver circuit 41 in order to provide the respective drive currents for the stator coils 35. The drive currents are applied to the stator coils 35 in such a manner that a driving magnetic field which is offset with respect to the main flux direction of the permanent magnet 37 is formed in the area of the armature, with respect to which the magnetic armature field produced by the permanent magnet is aligned. The offset of the driving magnetic field produced by the stator coils 35 can be selected in accordance with a desired driving torque.

To induce a secondary current into the coil winding 40 on the armature 36 in the linear synchronous motor 32, primary currents which lead to an alternating magnetic field in the direction of the winding axis of the coil winding 40 of the armature 36 are also applied to the stator coils 35.

In the exemplary embodiment shown, the winding axis of the coil winding 40 corresponds to the main flux direction of the permanent magnetic 37, but in other embodiments it is possible to separate the arrangement of the permanent magnet 37 and the arrangement of the coil winding 40 from one another and to arrange these at different positions on the armature 36. It should be essentially provided that the alternating magnetic field additionally applied by the primary currents impairs the driving of the armature 36 as little as possible, so that the coil winding 40 and the permanent magnet 37 are preferably arranged jointly on the armature projection 51.

The primary currents in the stator coils 35 are produced by an input coupling unit 42 in the drive unit 33, the primary currents being superimposed on the driving currents which are provided by the driver circuit 41, i.e. the driving currents and the primary currents are added to one another for each of the stator coil 35 which can be individually energized.

1.-11. (canceled)

12. A motor system, comprising a synchronous motor, said synchronous motor comprising:
a plurality of stator coils applying an alternating magnetic field;
an armature having at least one permanent magnet to produce a magnetic field in a main flux direction and a rotor on which the at least one permanent magnet is arranged to produce a magnetic field having at least one radial component with respect to a rotor axis;
at least one coil winding fitted to the armature and enclosing the at least one permanent magnet at least partially, wherein a component of the alternating magnetic field is induced in the coil winding which can be tapped off by a load arranged at the armature, said coil winding defining a winding axis and being arranged at the armature such that the winding axis extends in parallel relationship to the main flux direction; and
a control unit driving the synchronous motor by energizing the stator coils with a driving current in such a manner that a magnetic field is generated in a direction perpendicular to the main flux direction, said control unit being configured to superimpose on the driving current a primary current which generates the alternating magnetic field in the main flux direction of the at least one permanent magnet.

13. The motor system of claim 12, wherein the coil winding is connected to the load to apply the secondary current to the load as supply current.

14. The motor system of claim 12, wherein the at least one permanent magnet has poles lying in opposite relationship with respect to the rotor axis of the rotor.

15. The motor system of claim 12, wherein the control unit is constructed for superimposing on the driving current, on which the primary current is superimposed, a field weakening current so that a homogenous magnetic field is generated in the main flux direction to operate the synchronous motor in a field weakening mode.

16. A method for operating a synchronous motor, comprising:
a number of stator coils; and
an armature having at least one permanent magnet to produce a magnetic field in a main flux direction,
at least one coil winding fitted to the armature so that a secondary current, which can be tapped off by a load which can be arranged at the rotor can be induced in it by a component of an alternating magnetic field applied with the aid of the stator coils,
wherein the coil winding encloses the at least one permanent magnet at least partially,
wherein the armature has a rotor, with the at least one permanent magnet arranged at the rotor to produce a magnetic field having at least one radial component with respect to a rotor axis,
wherein the coil winding is arranged at the armature and defines a winding axis which extends in parallel relationship to the main flux direction, and
wherein the stator coils are energized with a driving current to drive the synchronous motor such that a driving magnetic field is generated in a direction perpendicular to the main flux direction, and a primary current is superimposed on the driving current and generates the alternating magnetic field in the main flux direction of the at least one permanent magnet.

17. The method of claim 16, wherein a field weakening current is superimposed on the driving current, on which the respective primary current is superimposed, to generate a homogenous magnetic field in the main flux direction so that a field weakening operation of the synchronous motor can be carried out.

18. A method for operating a synchronous motor, comprising the steps of:
producing a magnetic field in a main flux direction,
generating an alternating magnetic field by means of stator coils;
inducing a secondary current for a load by a component of the alternating magnetic field in at least one coil winding defined by a winding axis in parallel relationship to the main flux direction; and
energizing the stator coils with a driving current to operate the synchronous motor by generating a driving magnetic field in a direction perpendicular to the main flux direction and superimposing the driving current with a primary current which generates the alternating magnetic field in the main flux direction.

19. The method of claim 18, further comprising the steps of superimposing the driving current with a field weakening current to generate a homogenous magnetic field in the main flux direction, thereby enabling execution of a field weakening operation of the synchronous motor.
